(19) United States
(12) Patent Application Publication
(10) Pub. No.: US 2008/0114656 A1
(43) Pub. Date: May 15, 2008

(54) Airport radio

(75) Inventors: Brad D. Jersey, Wilsonville, OR (US); Grant W. Hammersley, Lake Oswego, OR (US)

Correspondence Address: ROBERT D. VARITZ, P.C., 4915 SE 33RD PLACE, PORTLAND, OR, 97202, US

(73) Assignee: Airport Marketing Income, L.L.C.

(21) Appl. No.: 11/983,301

(22) Filed: Nov. 8, 2007

Related U.S. Application Data
(60) Provisional application No. 60/859,431, filed on Nov. 15, 2006.

(51) Int. Cl. H04H 20/00; G06Q 30/00

(52) U.S. Cl. 705/14; 455/41.2

(57) ABSTRACT

An airport-specific radio broadcast system for broadcasting to a confined region in and about an airport having plural concourses therein includes a broadcast facility having at least one RF transmitter therein; receivers operably connected to a public speaker system in each airport concourse; broadcast content for broadcast to a specific concourse of the airport, wherein per-unit-time commitment of defined advertising time-slots in overall content material is broadcast by the broadcast system, including specific advertiser-associated time slots; content is broadcast in dwell-periods for through-passenger transit passengers, including a nominal dwell-period; and a defined ratio associating a predetermined count of broadcast advertising time-slots with the nominal dwell-period is used to determine content repetition.

### RELATED APPLICATION

This Application is related to and claims priority from U.S. Provisional Patent Application Ser. No. 60/859,431, for Airport Radio, filed Nov. 15, 2006.

### FIELD OF THE INVENTION

This invention relates to the establishment and management of an airport-specific radio station, which is controlled and operated entirely within that airport by, and under the control of, an appropriate airport management group, or at least under the control of a management group which guides the operation of such a station through a contracting radio-station service provider.

### BACKGROUND OF THE INVENTION

The concept of providing the passenger arrival, luggage collection, walking spaces, and concourses, etc., with flight information, announcement of a general nature, and pages to individuals present in the airport is well known. However, the concept of “filling” the passenger arrival, luggage collection, walking spaces, and concourses, etc., with an airport-specific stream of radio broadcast content, which may continuously be played over an airport's sound system to be heard by all passengers who are within that airport space has not been implemented. The broadcast may also be receivable in vehicles delivering and picking up passengers. Such an airport broadcast facility and practice offers a unique opportunity for radio-branding a specific airport, and for delivering to all personnel at least within the “passenger spaces” in the airport of airport-selected broadcast content, including a selected body of advertising content organized into suitably time-distributed time-slots.

It should be noticed that, as far as passengers within an airport are concerned, there is no opportunity to “switch radio stations” or to turn off such a radio broadcast. In other words, all passengers within the relevant “broadcast zone” will necessarily hear the entirety of broadcast content during the times that they are within such space.

### SUMMARY OF THE INVENTION

An airport-specific radio broadcast system for broadcasting to a confined region in and about an airport having plural concourses therein includes a broadcast facility having at least one RF transmitter therein; receivers operably connected to a public speaker system in each airport concourse; broadcast content for broadcast to a specific concourse of the airport, wherein per-unit-time commitment of defined advertising time-slots in overall content material is broadcast by the broadcast system, including specific advertiser-associated time slots; content is broadcast in dwell-periods for through-passenger transit passengers, including a nominal dwell-period; and a defined ratio associating a predetermined count of broadcast advertising time-slots with the nominal dwell-period is used to determine content repetition.

It is an object of the invention to provide a radio system for broadcasting music and information throughout the confines of a facility.

Another object of the invention is to provide such a radio system which uses a dwell-period to determine the repetition interval of information.

This summary and objects of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a schematic representation of an airport having four concourses.

FIG. 2 depicts plural timelines of broadcast information.

### DETAILED DESCRIPTION OF THE PREFERRED EMBODIMENTS

Music, announcements and advertising are frequently provided in facilities having large, public spaces to provide entertainment and information, such as in airports and in large shopping malls, wherein the airports and shopping malls have readily definable regions therein. An airport environment provides the setting for explanation of the instant invention. One of the special aspects of the present invention is the recognition that, with regard to the handling of passenger traffic in an airport, there are fundamentally three categories of airport passengers: (1) passengers who are arriving at the airport from outside to board a flight; (2) passengers who are in transit between flights, i.e., connecting passengers who have a connection “dwell-time”, or “dwell-period” between flights; and (3) passengers who have deplaned and are preparing to leave the airport. Additionally, other non-airport personnel include families, friends, etc., who enter an airport space for the purpose of greeting incoming passengers, or for the purpose of sending off and saying goodbye to departing passengers, as well as drivers and passengers in nearby vehicles.

A special feature of the invention which is associated with these characteristics of passengers recognizes an important link between “nominal” dwell-times, or dwell-periods, for passengers in transit between flights, with the idea that, within the full time period of such a nominal dwell-time, all or only a selected percentage of the totality of paid-for advertising content will be broadcast during those time periods so that passengers in transit will always be exposed to that full or selectively less than full stream of advertising content.

This concept of dwell-time/dwell-period recognizes that at different times of the year, or even at different times of day, the nominal or average dwell-period which characterizes passengers in transit in a airport may change, and the invention contemplates creating a relationship between such a change and the manner in which advertising content is delivered to recognize such a change. For example, a decision could be made whereby, under all circumstances, the full stream of advertising content is always delivered during the nominal dwell-period, with appropriate time-slot spacing for advertising being adjusted to accommodate this. The invention also contemplates the possibility that, in different specific airport concourses which are served by different specific airline carriers there are also different specific nominal connection times or dwell times (periods), and that radio broadcast content into these concourses may be specifically adjusted to reflect those dwell-time concourse differences, providing region-specific content.

A further recognition of the invention is that it is entirely possible to weight broadcast advertising content to relate to time of day or time of year, wherein certain kinds of advertising content are more relevant than at other times, and with respect to which the then actual broadcasting content which is best made available during a relevant dwell-time should be weighted in a certain manner.

Another consideration is that the distribution of vendors of products and services available to passengers in an airport may be such that advertising content which is most relevant to one concourse, or area, is less relevant than other advertising content which is most relevant in another concourse, or area. This kind of condition may be accommodated by the delivery of advertising content which is “vendor specific” to the specific airport passenger areas, in addition to the region-specific content.

Those who are skilled in the art, and who are skilled especially in the designing and delivering of advertising content over radio, will undoubtedly identify and think about other ways in which broadcast advertising content may be delivered in a tailored fashion with respect to a particular airport, and to particular spaces within that airport.

Programming on the facility-specific radio system of the invention includes background music, messaging and advertisements. The music may be compiled based on consumer demographics for a specific facility. Messaging allows a retailer effectively to communicate with potential customers through periodic announcements, while advertising may be directed to specific products available at retail outlets in the airport. Another feature of the invention is the “branding” of an airport by providing airport-specific content.

The programming is developed to provided six to eight minutes of messaging or advertising time in every hour of music during all hours of operation. Advertising time is typically divided into spots having a duration of between about 10 to 30 seconds each. Programming production follows methods used in conventional radio stations, however, the programming is customized for the airport environment. Industry standards, such as Audio Vault and RCE, are used in the programming process.

The music, messaging and advertisements create a dynamic environment which is believed to be enjoyable for the people transiting or visiting the airport. Travelers and visitors are positively impacted while spending a considerable amount of dwell time at an airport. The programming also provided retailers with an opportunity to differentiate and strengthen their brand and/or identity. Careful analysis of customer demographics and product availability insures that the broadcast information is beneficial to both consumers and retailers.

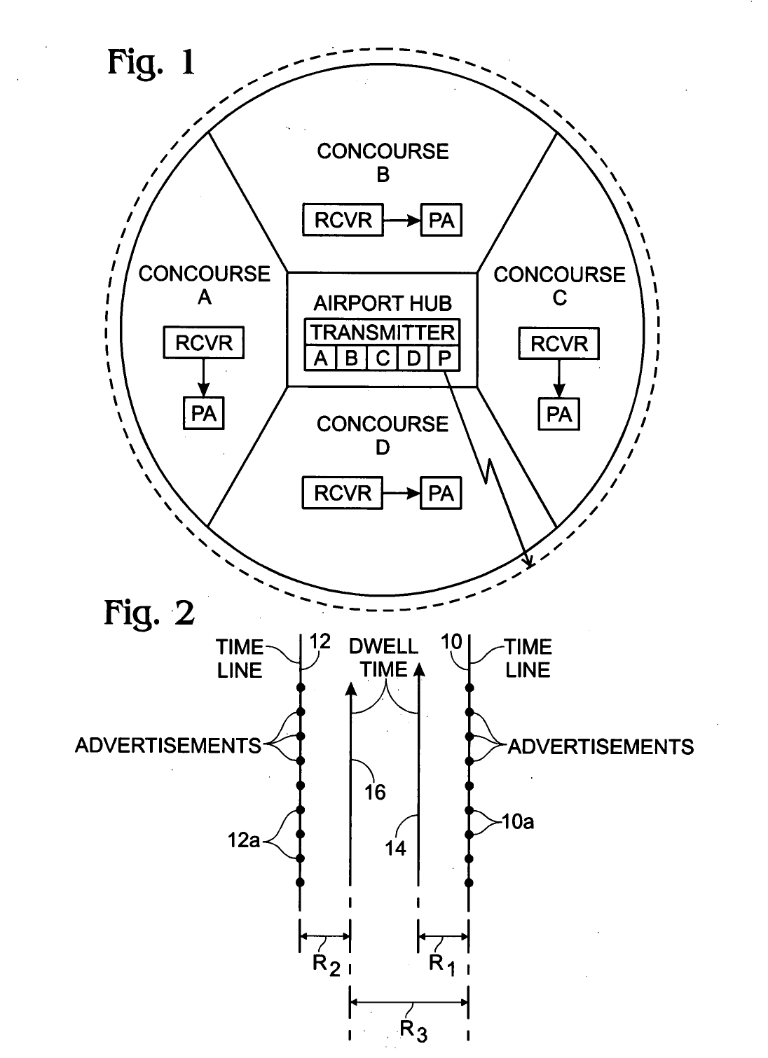

Referring now to FIG. 1, a very schematic illustration of an airport, which has four concourses, referred to herein as public spaces: A, B, C and D, is depicted. A peripheral region, P, extends about the airport. Again, it will be appreciated by one of ordinary skill in the art that the radio system of the invention may be used in any facility which has a significant number of people transiting its public spaces. The dashed-line circle appearing in FIG. 1 schematically represents confined reach of the facility-specific, e.g., airport-specific, broadcasting, which extends beyond the perimeter of the concourse, but is of limited range outside of the airport confines, again, designated region P, wherein airport shuttle buses and other motorized vehicles may receive the content using RF receivers. It is within this airport and its concourses that radio presence exists, with advertising content being distributed in time-slots appropriate to the nominal dwell-time which characterizes this airport, and/or to the nominal dwell-times/dwell-periods which may characterize passenger transit times in each of the four illustrated concourses. It will be appreciated by one of ordinary skill in the art that the content of the airport radio system is broadcast by RF from one or more locations, identified as “Transmitter”, to one or more receivers, identified as “RCVR”, which receivers are connected to an airport public address system (PA) in each concourse, providing region-specific and vendor-specific content to the various concourses. To facilitate acceptance of the system of the invention, conventional airport public address system may be replaced or augmented with high-quality, high-fidelity speakers, thus rendering the content understandable by persons in the airport public areas. A RF sub-system provides convention short-range broadcast which is receivable by conventional AM/FM radio receivers, providing the content to persons approaching or leaving the airport confines in motor vehicles.

FIG. 2 depicts two timelines, 10 and 12, which represent time-flows of broadcasting, with indicia 10a, 12a, being distributed along these lines to represent specific advertisements, or advertisement time-slots. Shown immediately to the left of timeline 10 is an arrow 14 whose length represents a nominal airport dwell-period, which substantially matches the total distribution time-length along timeline 10 of advertising time-slots 10a. A similar arrow 16 appears immediately to the right of timeline 12, with this arrow possessing a length substantially matching the overall time distribution of advertising time-slots 12a. Arrow 14 is depicted having a length longer than that of arrow 16.

If one assumes that the distribution of advertising time-slots appearing along line 10 represents 100% of paid-for advertising in a particular circumstance, line 10, along with arrow 14, illustrate a condition wherein 100% of advertising content is distributed in every nominal dwell time whose length is represented by arrow 14. In other words, no matter when one begins to measure the beginning of a dwell-time, at the end of that dwell-time, all advertising content will have been delivered to the airport space whose dwell-time is characterized by arrow 14. The designator R₁ represents a ratio, in a sense, of the percentage of advertising which is made available to passengers during a selected dwell-time, and in FIG. 2, this ratio R₁ indicates that 100% of paid-for advertising in time-slots is delivered during every nominal dwell-period.

A comparison between line 10 and arrow 14 on the one hand, and line 12 and arrow 16 on the other, directly provides an illustration of how, if a nominal dwell-time changes for one reason or another, and specifically is shorter, as illustrated by arrow 16, it is possible through practice of the invention to create an advertising percentage ratio R₂ which is also 100%—meaning that all advertising content is now distributed completely within the shortened dwell-time thus illustrated. This is accomplished, of course, by changing the time spacings that occur between the individual advertising time-slots, and this is made evident by the closer spacing of dots 12a along line 12 than the spacing of dots 10a along line 10.

FIG. 2 also illustrates another kind of condition wherein a decision has been made that only a somewhat less than 100% broadcast of advertising will occur during a nominal dwell-time. This condition is illustrated by looking at timeline 10 along with arrow 16. What these two drawing elements illustrate is that, during a nominal dwell-time represented by arrow 16, a ratio R₃ exists, whereby about 78% of all advertising content is broadcast during every dwell-time period which is represented with the length shown for arrow 16 in FIG. 2.

These several illustrations which are given in FIG. 2 are, of course, representative only of just a very few ways in which advertising delivery can be tailored to a particular airport, and to particular spaces within an airport. Weighting, as generally mentioned above, may also take a number of different forms to account for different kinds of conditions, such as time of year, time of season, time of day, and distribution of vendors of services and products.

The airport broadcast concept of this invention thus offers a unique opportunity to create a special radio voice for a specific airport, thus to brand it with a particular airport personality, and to offer a unique opportunity for advertisers of products and services to deliver their messages in meaningful ways to people, and especially to transit passengers, within an airport space. It will be appreciated that, in addition to the content provided by the system of invention, public service announcements, such as gate and flight changes, and TSA announcements may also be provided over the speakers of the system.

Thus, a model of an airport radio system has been disclosed. It will be appreciated that further variations and modifications thereof may be made within the scope of the invention as defined in the appended claims.

We claim:

1. A facility-specific radio broadcast system confined to broadcasting within a reach including a public space comprising:
per-unit-time commitment of defined advertising time-slots in overall content material which is broadcast by the broadcast system, including specific advertiser-associated time slots;
dwell-periods associated with public transit intervals, including a nominal dwell-period; and
a defined ratio associating a predetermined count of broadcast advertising time-slots, with the nominal dwell-period.

2. The subject matter of claim 1 wherein the nominal dwell-period has different norms or nominal lengths during different periods of time, and the defined ratio is made to be selectively adjustable in relation to those different norms.

3. The subject matter of claim 1 wherein the defined ratio may be less than 100%, with, accordingly, not all time-slots being assigned to occur within each given nominal dwell-period.

4. The subject matter of claim 1 wherein the nominal dwell-period and the defined ratio may be affected by different variables including, without limitation, time of day, time of year, advertisers and vendors associated with different specific public spaces.

5. An airport-specific radio broadcast system for broadcasting to a confined region in and about an airport having plural concourses therein comprising:
a broadcast facility having at least one RF transmitter therein;
receivers operably connected to a public speaker system in each airport concourse;
broadcast content for broadcast to a specific concourse of the airport, wherein
per-unit-time commitment of defined advertising time-slots in overall content material is broadcast by the broadcast system, including specific advertiser-associated time slots;
content is broadcast in dwell-periods for through-passenger transit passengers, including a nominal dwell-period; and
a defined ratio associating a predetermined count of broadcast advertising time-slots with the nominal dwell-period is used to determine content repetition.

6. The system of claim 5 which includes RF broadcast to an area outside of the airport concourse for reception by persons outside of the airport concourse.

7. The system of claim 5 wherein the nominal dwell-period has different norms or nominal lengths during different periods of time, and the defined ratio is made to be selectively adjustable in relation to those different norms.

8. The system of claim 5 wherein the defined ratio may be less than 100%, with, accordingly, not all time-slots being assigned to occur within each given nominal dwell-period.

9. The system of claim 5 wherein the nominal dwell-period and the defined ratio may be affected by different variables including, without limitation, time of day, time of year, concourse assignments made to different specific airlines, advertisers and vendors associated with different specific concourses and passenger spaces.

10. An airport-specific radio broadcast system for broadcasting to a confined region in and about an airport having plural concourses therein comprising:
a broadcast facility having at least one RF transmitter therein;
receivers operably connected to a public speaker system in each airport concourse;
broadcast content for broadcast to a specific concourse of the airport, wherein
per-unit-time commitment of defined advertising time-slots in overall content material is broadcast by the broadcast system, including specific advertiser-associated time slots;
content is broadcast in dwell-periods for through-passenger transit passengers, including a nominal dwell-period;
a defined ratio associating a predetermined count of broadcast advertising time-slots with the nominal dwell-period is used to determine content repetition; and which further includes RF broadcast to an area outside of the airport concourse for reception by persons outside of the airport concourse.

11. The system of claim 10 wherein the nominal dwell-period has different norms or nominal lengths during different periods of time, and the defined ratio is made to be selectively adjustable in relation to those different norms.

12. The system of claim 10 wherein the defined ratio may be less than 100%, with, accordingly, not all time-slots being assigned to occur within each given nominal dwell-period.

13. The system of claim 10 wherein the nominal dwell-period and the defined ratio may be affected by different variables including, without limitation, time of day, time of year, concourse assignments made to different specific airlines, advertisers and vendors associated with different specific concourses and passenger spaces.
